(19) United States
(12) Patent Application Publication
(10) Pub. No.: US 2024/0205264 A1
(43) Pub. Date: Jun. 20, 2024

(54) SYSTEM AND METHOD FOR DETECTING AND BLOCKING PHISHING ATTACKS EMBEDDED IN NOISY IMAGES

(71) Applicant: Barracuda Networks, Inc., Campbell, CA (US)

(72) Inventor: Christopher L. Sawtelle, Santa Clara, CA (US)

(21) Appl. No.: 18/533,055

(22) Filed: Dec. 7, 2023

Related U.S. Application Data
(60) Provisional application No. 63/432,965, filed on Dec. 15, 2022.

(51) Int. Cl. H04L 9/40; G06T 5/70; G06V 30/10

(52) U.S. Cl. CPC H04L 63/1483; G06T 5/70; G06V 30/10

(57) ABSTRACT

A method includes receiving an image embedded with text and injected with noise. A new image is generated based on the received message, wherein the new image includes the image embedded with the text wherein the noise is reduced in comparison to the received image. The embedded text is identified from the new image. The method further includes determining whether the embedded text poses a cybersecurity threat.

### CROSS-REFERENCE TO RELATED APPLICATIONS

This application claims the benefit and priority to the U.S. Provisional Patent Application No. 63/432,965, filed Dec. 15, 2022, which is incorporated herein in its entirety by reference.

### BACKGROUND

Phishing attack is specific type of cyber-attack that has been on the rise wherein the sender of an e-mail masquerades as a trustworthy sender in an attempt to deceive the recipient into providing personal identity data or other sensitive information including but not limited to account usernames, passwords, social security number or other identification information, financial account credentials (such as credit card numbers) or other information, etc., to the sender by a return e-mail or similar electronic communication.

Phishing attacks continue to evolve with further layers of obfuscation for the intent of attack. Many attacks are now based on text embedded in images. A common method for detecting these attacks is to use an Optical Character Recognition (OCR) algorithm. Attackers often inject images with noise, e.g., random noise, to defeat text extraction methods while maintaining human readability.

The foregoing examples of the related art and limitations related therewith are intended to be illustrative and not exclusive. Other limitations of the related art will become apparent upon a reading of the specification and a study of the drawings.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a machine learning unit configured to generate a machine learning (ML) model for generating an image with reduced noise according to one aspect of the present embodiments.

FIG. 2 depicts an example of a system that uses an ML model to generate a new image from an input image, with reduced noise, and to determine whether the received image poses a threat according to one aspect of the present embodiments.

FIG. 3 is a relational node diagram depicting an example of a neural network for generating an ML model to generate an image with reduced noise from an image injected with noise according to some embodiments.

FIG. 4 depicts a flowchart of an example of a process to generate an ML model to reduce noise in an image according to one aspect of the present embodiments.

FIG. 5 depicts a flowchart of an example of a process to determine whether a received image poses a threat using an ML model according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

A new approach is proposed to analyze an electronic message (e.g., an email, instant message, social media message, social media post, etc.) with an image within it (or link to an image that is downloadable) for security threats, e.g., cyberattacks, spam, phishing, etc. According to some embodiments, systems and methods train a machine learning (ML) algorithm and generate an ML model. The ML model is generated based on an image (training image) that is embedded with text as well as added noise. The generated ML model when applied removes the added noise (or reduces it) from an image that is embedded with text. The text may subsequently be extracted from the image to determine the security threat associated with the message (and/or the image and/or text within the image). For example, a message (e.g., an email, instant message, social media message, social media post, etc.) may be received. The received email may include an image or a link to an image where the image is embedded with a text and where noise is added to the image in order to obfuscate the text within the image. The generated ML model may be applied to the image in order to reduce and/or remove the added noise from the received image. The generated ML model generates a new image from the received image where the new image is the received message (e.g., an email, instant message, social media message, social media post, etc.) with reduced noise (or no noise). As such, an image with embedded text and added noise (by an attacker) to obfuscate the text is recovered and repaired to its original state without noise (or reduced noise). In other words, noise is substantially removed (by using the generated ML model) without having to estimate the noise. The new image generated by the ML model (with reduced noise) may be fed into an optical character recognition (OCR) unit to detect the embedded text within the image (generate computer readable string). The detected text may be used by a natural language classification unit to detect threat, if any, associated with the text and/or the image and/or the message. For example, natural language classification may be used to determine whether the received message (e.g., an email with an image, instant message with an image, social media message with an image, social media post with an image, etc.) is spam or a phishing expedition. Natural language classification unit may leverage natural language processing to identify and determine the text. As such, cyberattacks by an attacker that add noise to an image embedded with text may be subverted and addressed.

As referred to hereinafter, electronic messages or messages include but are not limited to electronic mails or emails, text messages, instant messages, online chats on a social media platform, social media posts, voice messages or mails that are automatically converted to be in an electronic text format, or other forms of text-based electronic communications.

In one nonlimiting example, a generative adversarial network (GAN) is used to generate an ML model. For example, an image may be embedded with text (e.g., text added to an image) and noise may be added/injected, e.g., Gaussian, White, etc., using a generator unit within the GAN. The obfuscated image is then fed into a discriminator unit to determine how close the new image is to its noiseless representation. The process may be repeated for the same image, with different texts and/or different noise (e.g., different distribution, different noise level, etc.), etc. It is appreciated that the process may also be repeated for a different image, same or different texts, and/or same or different noise, etc. The ML model may be generated.

The system may receive a message with a new image (or link to an image). The generated ML model is applied to the newly received image in order to generate an image corresponding to the new image but without noise (or reduced noise), which is then transmitted to an OCR unit to detect a text within the image. The detected text may be sent to a natural language classification unit in order to determine whether the text and/or the image and/or the message pose a security threat. Appropriate action(s) may be taken based on the determination of whether the image and/or text and/or the message pose a security threat, e.g., phishing, cyber-attack, spam, etc., or not. For example, if it is determined that the text within the image poses a security threat then the message with the image may be deleted and becomes inaccessible by the user or in some embodiments it may be quarantined. In one nonlimiting example, the message as a whole may become inaccessible if it is determined that the message with the image poses a security threat. However, if it is determined that the text within the image and/or the image and/or the message do not pose a security threat, then the image may be provided to the end user for access.

Accordingly, the embodiments counter potential attack by an attacker by repairing the image with a neural network rather than having to identify/detect noise and subsequently removing the noise through conventional methods. In other words, the embodiments generate noiseless images (or reduced noise images) without approximating the noise or having any knowledge of the noise distribution, thereby resulting in an improved accuracy of text extraction.

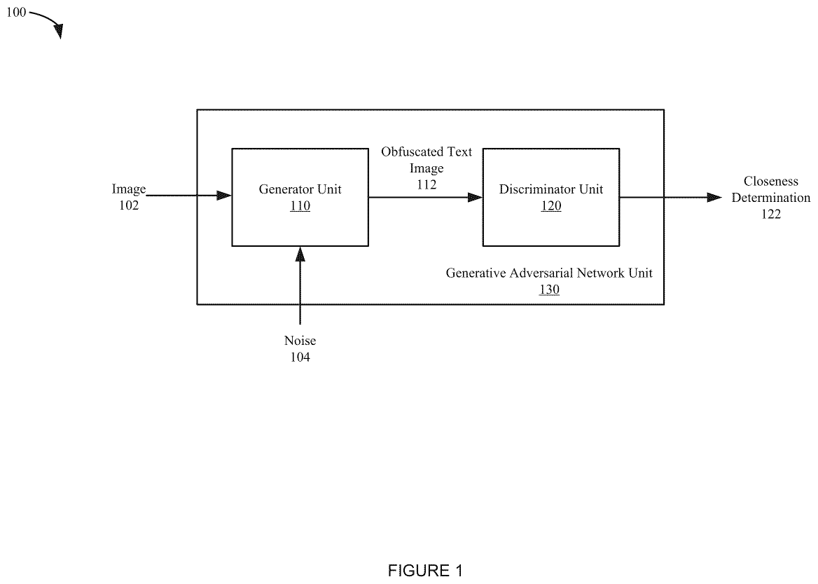

FIG. 1 depicts an example of a machine learning (ML) unit configured to generate a machine learning model for generating an image with reduced noise according to one aspect of the present embodiments. In this nonlimiting example, the ML unit is a generative adversarial network (GAN) unit 130 that includes a generator unit 110 coupled to a discriminator unit 120.

It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

Each of these components in the system 120 is/runs on one or more computing units/appliances/devices/hosts (not shown) each having one or more processors and software instructions stored in a storage unit such as a non-volatile memory of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

In the example of FIG. 1, each computing unit can be a computing device, a communication device, a storage device, or any computing device capable of running a software component. For non-limiting examples, a computing device can be but is not limited to a server machine, a laptop PC, a desktop PC, a tablet, a Google Android device, an iPhone, an iPad, and a voice-controlled speaker or controller. Each of these components in the system is associated with one or more communication networks (not shown), which can be but is not limited to, Internet, intranet, wide area network (WAN), local area network (LAN), wireless network, Bluetooth, Wi-Fi, and mobile communication network for communications among the engines. The physical connections of the communication networks and the communication protocols are well known to those skilled in the art.

In one nonlimiting example, an image 102, e.g., image of a dog, image of a cat, image of a traffic sign, etc., that is embedded with a text, e.g., string of characters, may be transmitted to the generator unit 110 of the GAN unit 130. The generator unit 110 is configured to inject the received image 102 with noise 104, e.g., Gaussian noise, white noise, random noise, etc. It is appreciated that noise 104 may have a type as well as noise amount or level. As such, the generator unit 110 generates an obfuscated text image 112. The obfuscated text image 112 is the original image 102 (that includes the image with the embedded text) after noise 104 is added.

The obfuscated text image 112 is sent to the discriminator unit 120. The discriminator unit 120 is configured to determine how close the obfuscated text image 112 is to the original representation of the image, e.g., image 102, before it is injected with noise 104. The closeness determination 122 is output from the discriminator unit 120.

It is appreciated that the described process may be repeated for the same image 102 with a different type of noise and/or different level of noise, etc. In some nonlimiting examples, the described process may be repeated for a different image (e.g., different image and/or different embedded text). It is appreciated that the process may be repeated a number of times (iterations) until the ML model is created. Once the ML model is created it can be deployed for field use, as described below.

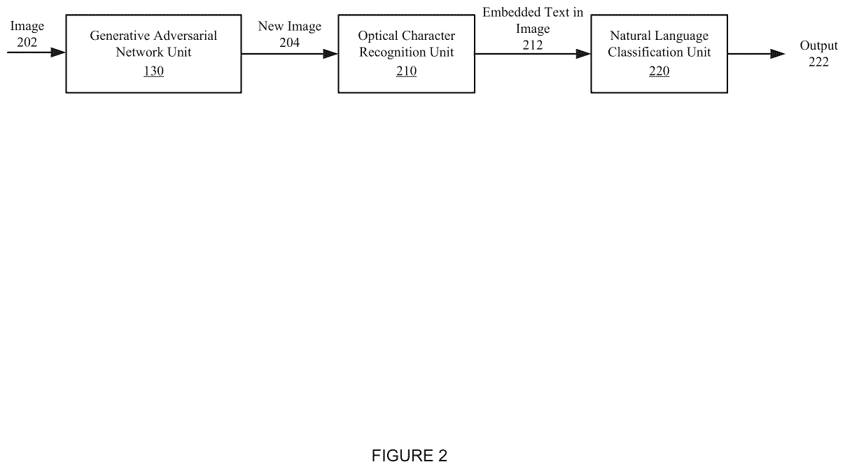

FIG. 2 depicts an example of a system that uses an ML model to generate a new image from an input image, with reduced noise, and to determine whether the received image poses a threat according to one aspect of the present embodiments. Once the ML model is generated it can be used in the field and be applied to a received image in order to reduce its noise, if any. In this nonlimiting example, a message is received. The message may be an email, an instant message, a social media message, a social media post, etc. The message may include an image 202 or it may include a link to an image that can be downloaded as image 202. The image 202 may be an image that is embedded with text (e.g., text string). In some examples, the image 202 may also be injected with noise, by an attacker, in order to obfuscate the text for OCR purposes to make the attack such as phishing or spam, etc., more effective

However, the GAN unit 130 may apply the generated ML model to the image 202 in order to generate a new image 204 from the received image 202. The new image 204 includes the image within the image 202 and its embedded text but with reduced (or no) noise. It is appreciated that the GAN unit 130 of FIG. 2 may also include the generator unit 110 and the discriminator unit 120 where the generator unit 110 generate the new image 204 using the ML model and where the discriminator unit 120 determines how close the new image 204 to the image 202 but without noise. The new image 204 is transmitted to the OCR unit 210 to detect and determine the text embedded text in image 212 within the new image 204. Since the noise has been reduced in the new image 204 using the ML model, the OCR unit 210 can more effectively detect and determine the embedded text within the image 202. The embedded text in image 212 is subsequently transmitted to the natural language classification unit 220 for further processing. The natural language classification unit 220 is configured to determine whether the received message and/or the image 202 within the message and/or the text embedded within the image 202 poses a security risk, e.g., phishing, spam, etc. The natural language classification unit 220 is configured to output 222 its determination. The system may take appropriate actions based on the output 222. For example, the message and/or the image and/or the text embedded within the image may be quarantined if the natural language classification unit 220 determines that the message and/or the image and/or the text embedded within the image pose a security risk. In another example, the message and/or the image and/or the text embedded within the image may be blocked off and become inaccessible to the user if the natural language classification unit 220 determines that the message and/or the image and/or the text embedded within the image pose a security risk. On the other hand, the message and/or the image and/or the text embedded within the image may become available to the user if it is determined that there is no security risk associated therewith.

It is appreciated that the embodiments are described with respect to GAN for illustration purposes that should not be construed as limiting the scope of the embodiments. For example, other types of neural network algorithms may similarly be used.

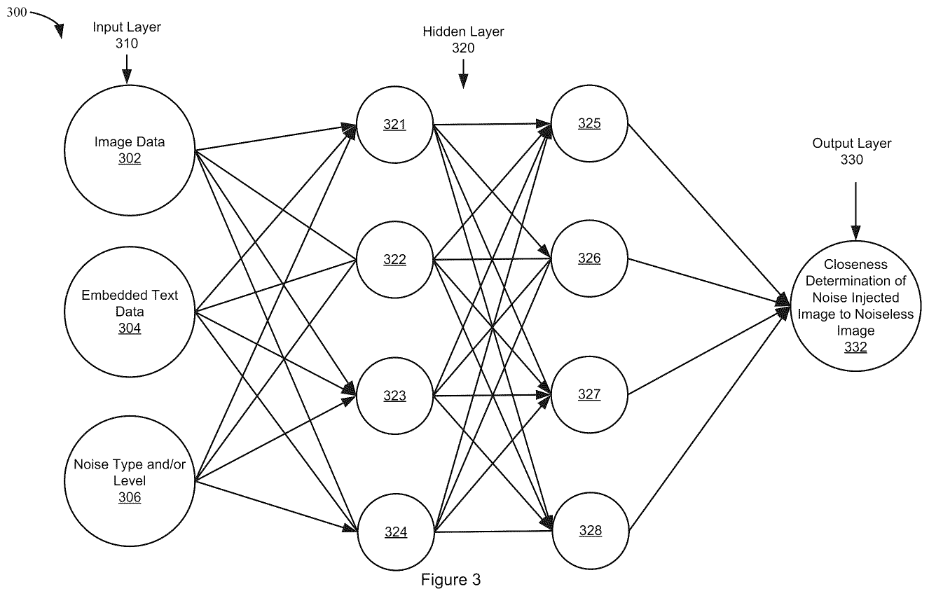

FIG. 3 is a relational node diagram depicting an example of a neural network for generating an ML model to generate an image with reduced noise from an image injected with noise, according to some embodiments. In an example embodiment, the neural network 300 utilizes an input layer 310, one or more hidden layers 320, and an output layer 330 to train the machine learning algorithm(s) or model to generate an ML model for removing or reducing noise injected into an image with embedded text. In some embodiments, where the image data 302 (e.g., actual image), the embedded text data 304 (embedded within the actual image), and the noise type and/or level 306 (noise injected having a particular type and/or level/amount), as described above, have already been confirmed as well as the closeness of the actual image with noise injected to the image without noise (or reduced noise), supervised learning is used such that known input data, a weighted matrix, and known output data are used to gradually adjust the model to accurately compute the already known output. Once the model is trained, field data is applied as input to the model and a predicted output is generated. In other embodiments, where the closeness determination of noise injected image to noiseless image has not yet been confirmed, unstructured learning is used such that a model attempts to reconstruct known input data over time in order to learn. FIG. 3 is described as a structured learning model for depiction purposes and is not intended to be limiting.

Training of the neural network 300 using one or more training input matrices, a weight matrix, and one or more known outputs is initiated by one or more computers associated with the system. In an embodiment, a server may run known input data through a deep neural network in an attempt to compute a particular known output. For example, a server uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server computer then re-computes another output from the deep neural network with the input training matrix and the adjusted weight matrix. This process continues until the computer output matches the corresponding known output. The server computer then repeats this process for each training input dataset until a fully trained model is generated.

In the example of FIG. 3, the input layer 310 includes a plurality of training datasets that are stored as a plurality of training input matrices in a database associated with the system. The training input data includes, for example, image data 302 (different images), embedded text data 304 (different text strings including plain text, ciphertext, etc.), and noise type and/or level 306 (e.g., Gaussian noise, random noise, white noise, etc., each with certain level/amount). Any type of input data can be used to train the model.

In an embodiment, image data 302 is used as one type of input data to train the model, which is described above. In some embodiments, embedded text data 304 are also used as another type of input data to train the model, as described above. Moreover, in some embodiments, noise type and/or level 306 within the system are also used as another type of input data to train the model, as described above.

In the embodiment of FIG. 3, hidden layers 320 represent various computational nodes 321, 322, 323, 324, 325, 326, 327, 328. The lines between each node 321, 322, 323, 324, 325, 326, 327, 328 represent weighted relationships based on the weight matrix. As discussed above, the weight of each line is adjusted overtime as the model is trained. While the embodiment of FIG. 3 features two hidden layers 320, the number of hidden layers is not intended to be limiting. For example, one hidden layer, three hidden layers, ten hidden layers, or any other number of hidden layers may be used for a standard or deep neural network. The example of FIG. 3 also features an output layer 330 with the closeness determination of noise injected image to noiseless image 332 as the known output. As discussed above, in this structured model, the closeness determination of noise injected image to noiseless image 332 is used as a target output for continuously adjusting the weighted relationships of the model. When the model successfully outputs the closeness determination of noise injected image to noiseless image 332, then the model has been trained and may be used to process live or field data.

Once the neural network 300 of FIG. 3 is trained, the trained model will accept field data at the input layer 310, such as actual message with an image or link to an image with embedded text and injected with noise. In some embodiments, the field data is live data that is accumulated in real time. In other embodiments, the field data may be current data that has been saved in an associated database. The trained model is applied to the field data in order to generate one or more closeness determination of noise injected image to noiseless image at the output layer 330. Moreover, a trained model can determine that closeness determination of noise injected image to noiseless image is appropriate as more data is processed and accumulated over time. Consequently, the trained model will determine the closeness determination of noise injected image to noiseless image over time. Moreover, the trained model will determine the appropriate changes to be made to the closeness determination of noise injected image to noiseless image.

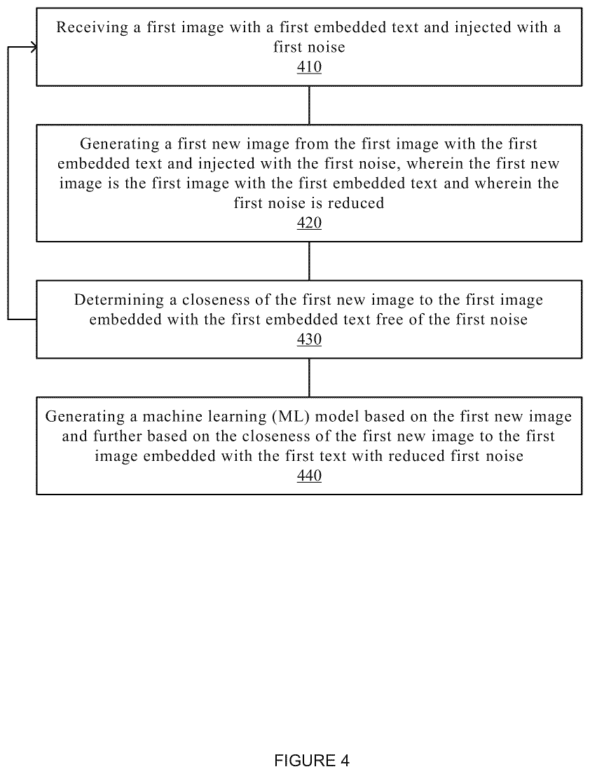

FIG. 4 depicts a flowchart of an example of a process to generate an ML model to reduce noise in an image according to one aspect of the present embodiments. At step 410, a first image with a first embedded text and injected with a first noise is received. Noise may be any noise such as Gaussian noise, white noise, etc., with any level/amount. At step 420, a first new image is generated from the first image with the first embedded text and injected with the first noise, wherein the first new image is the first image with the first embedded text and wherein the first noise is reduced. At step 430, a closeness of the first new image to the first image embedded with the first embedded text free of the first noise is determined. It is appreciated that steps 410-430 may be repeated a number of times (iterations) where the image and/or the embedded text and/or the noise is varied. At step 440, a machine learning (ML) model is generated based on the first new image and further based on the closeness of the first new image to the first image embedded with the first text with reduced first noise.

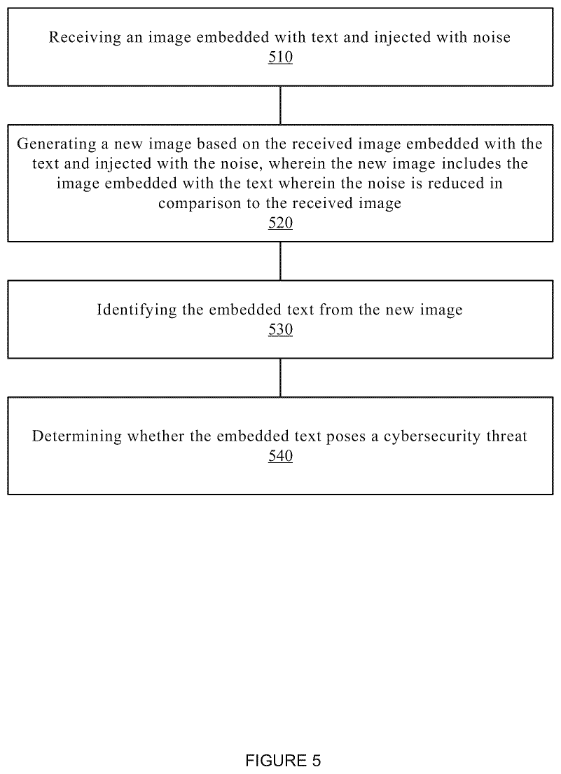

FIG. 5 depicts a flowchart of an example of a process to determine whether a received image poses a threat using an ML model according to one aspect of the present embodiments. At step 510, an image (e.g., within a message like an email or link within a message that points to an image that is downloadable, an instant message, a social media message, a social media post, etc.) embedded with text and injected with noise (e.g., Gaussian noise, white noise, etc., with different level/amount) is received. At step 520, a new image is generated (e.g., using an ML model) based on the received image embedded with the text and injected with the noise. The new image includes the image embedded with the text wherein the noise is reduced in comparison to the received image. At step 530, the embedded text is identified from the new image. At step 540, it is determined whether the embedded text poses a cybersecurity threat (e.g., phishing, spam, etc.). In some nonlimiting examples, if it is determined that the embedded text poses the cybersecurity threat then access to the received image is prevented.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system, comprising:
a generative adversarial network (GAN) unit configured to
receive an image embedded with text and injected with noise;
generate a new image based on the received message, wherein the new image includes the image embedded with the text wherein the noise is reduced in comparison to the received image; and
send the new image as output from the GAN unit;
an optical character recognition (OCR) unit configured to receive the new image as received from the GAN unit and further configured to identify the embedded text; and
a natural language classification unit configured to receive the identified embedded text from the OCR unit and further configured to determine whether the embedded text poses a cybersecurity threat.

2. The system of claim 1, wherein the noise is a Gaussian noise.

3. The system of claim 1, wherein the noise is a white noise.

4. The system of claim 1, wherein the GAN unit includes a generator unit configured to generate the new image and wherein the GAN unit further includes a discriminator unit configured to determine closeness of the new image to the image prior to the noise injection.

5. The system of claim 1, wherein the cybersecurity threat is one of a phishing attack or spam.

6. The system of claim 1, wherein the image is within a message being received.

7. The system of claim 6, wherein the message is one of an email message, an instant message, a social media message, or a social media post.

8. The system of claim 1, wherein a user is prevented from accessing the received image in response to determining that the embedded text poses the cybersecurity threat.

9. The system of claim 1, wherein the GAN unit applies a machine learning (ML) model to generate the new image.

10. A method comprising:
receiving a first image with a first embedded text and injected with a first noise;
generating a first new image from the first image with the first embedded text and injected with the first noise, wherein the first new image is the first image with the first embedded text and wherein the first noise is reduced;
determining a closeness of the first new image to the first image embedded with the first embedded text free of the first noise; and
generating a machine learning (ML) model based on the first new image and further based on the closeness of the first new image to the first image embedded with the first text with reduced first noise.

11. The method of claim 10 further comprising:
receiving the first image with a second embedded text and injected with the first noise;
generating a second new image from the first image with the second embedded text and injected with the first noise, wherein the second new image is the first image with the second embedded text and wherein the first noise is reduced; and
determining a closeness of the second new image to the first image embedded with the second embedded text free of the first noise,
wherein the generating the ML model is further based on the second new image.

12. The method of claim 10 further comprising:
receiving the first image with the first embedded text and injected with a second noise;
generating a second new image from the first image with the first embedded text and injected with the second noise, wherein the second new image is the first image with the first embedded text and wherein the second noise is reduced; and
determining a closeness of the second new image to the first image embedded with the first embedded text free of the second noise,
wherein the generating the ML model is further based on the second new image.

13. The method of claim 10 further comprising:
receiving a second image with the first embedded text and injected with the first noise;
generating a second new image from the second image with the first embedded text and injected with the first noise, wherein the second new image is the second image with the first embedded text and wherein the first noise is reduced; and
determining a closeness of the second new image to the second image embedded with the first embedded text free of the first noise,
wherein the generating the ML model is further based on the second new image.

14. The method of claim 10 further comprising:
receiving a second image with a second embedded text and injected with the first noise;
generating a second new image from the second image with the second embedded text and injected with the first noise, wherein the second new image is the second image with the second embedded text and wherein the first noise is reduced; and
determining a closeness of the second new image to the second image embedded with the second embedded text free of the first noise,
wherein the generating the ML model is further based on the second new image.

15. The method of claim 10 further comprising:
receiving a second image with the first embedded text and injected with a second noise;
generating a second new image from the second image with the first embedded text and injected with the second noise, wherein the second new image is the second image with the first embedded text and wherein the second noise is reduced; and
determining a closeness of the second new image to the second image embedded with the first embedded text free of the second noise,
wherein the generating the ML model is further based on the second new image.

16. The method of claim 10 further comprising:
receiving a second image with a second embedded text and injected with a second noise;
generating a second new image from the second image with the second embedded text and injected with the second noise, wherein the second new image is the second image with the second embedded text and wherein the second noise is reduced; and
determining a closeness of the second new image to the second image embedded with the second embedded text free of the second noise,
wherein the generating the ML model is further based on the second new image.

17. A method comprising:
receiving an image embedded with text and injected with noise;
generating a new image based on the received image embedded with the text and injected with the noise, wherein the new image includes the image embedded with the text wherein the noise is reduced in comparison to the received image;
identifying the embedded text from the new image; and
determining whether the embedded text poses a cybersecurity threat.

18. The method of claim 17, wherein the noise is a Gaussian noise.

19. The method of claim 17, wherein the noise is a white noise.

20. The method of claim 17, wherein the cybersecurity threat is one of a phishing attack or spam.

21. The method of claim 17, wherein the image is within a message.

22. The method of claim 21, wherein the message is an email message.

23. The method of claim 17 further comprising preventing a user from accessing the received image in response to determining that the embedded text poses the cybersecurity threat.

24. The method of claim 17, wherein the new image is generated by applying a machine learning (ML) model.
